(19) United States
(12) Patent Application Publication
(10) Pub. No.: US 2007/0224341 A1
(43) Pub. Date: Sep. 27, 2007

(54) Method for the Modification of Chiral Liquid-Crystal Films with the Aid of Extractants

(76) Inventors: Matthias Kuntz, Seehiem-Jugenheim (DE); Robert Hammond-Smith, Hampshire (GB); Rodney Riddle, Dorset (GB); John Patrick, Dorset (GB); Michael Ukelis, Riedstadt (DE); Siegfried Schmitzer, Kuernach (DE); Peter Schmitt, Wuerzburg (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/580,034

(22) PCT Filed: Nov. 4, 2004
(86) PCT No.: PCT/EP04/12466

§ 371 Date: May 21, 2007

(30) Foreign Application Priority Data
Nov. 21, 2003 (EP) 03026750.4

(51) Int. Cl. C08J 7/02; G02B 5/30

(52) U.S. Cl. 427/162; 428/1.1

(57) ABSTRACT

The invention relates to a method in which a chiral liquid-crystal layer is brought into contact with an extraction medium (extractant) by coating or printing methods in such a way that diffusion of substances out of the liquid-crystal layer into the extractant occurs.

The invention relates to a method for the modification of chiral liquid-crystal films, in particular of their reflection wavelength, in which a chiral liquid-crystal layer is brought into contact with a liquid extraction medium (extractant) by coating or printing methods in such a way that diffusion of substances out of the liquid-crystal layer into the extractant occurs.

In cholesteric or chiral-nematic liquid-crystal (LC) materials in general, the liquid-crystal molecules form a helical superstructure which is perpendicular to the longitudinal molecular axis.

The terms “chiral-nematic” and “cholesteric” are used alongside one another in the prior art. The term “chiral-nematic” is frequently applied to LC materials consisting of a nematic host mixture doped with an optically active component, which induces a helically twisted superstructure in the host mixture. By contrast, the term “cholesteric” is often used for chiral LC materials which have a “natural” cholesteric phase with a helical twist, such as, for example, cholesteryl derivatives. The two terms are often also used to denote the same thing. In the present application, the term “cholesteric” is used for both above-mentioned types of LC materials, where this term is intended to cover the respectively broadest meaning of “chiralnematic” and “cholesteric”.

The term “liquid-crystalline compound” or “mesogenic compound”, as mentioned above and below, encompasses compounds having one or more rod-shaped, plank-shaped or disc-shaped mesogenic groups, i.e. groups which are able to induce a mesophase or liquid-crystal phase. Compounds having rod-shaped or plank-shaped groups are also known as “calamitic” liquid crystals, compounds having disc-shaped groups are also known as “discotic” liquid crystals. The mesogenic compounds may themselves form liquid-crystal phases. However, it is also possible that they only form liquid-crystal phases when mixed with other compounds or after polymerisation.

The remarkable optical properties of the cholesteric phase consist in high optical rotation and pronounced circular dichroism, which occurs due to selective reflection of circular-polarised light within the layer. The colours, which appear different depending on the viewing angle, are dependent on the pitch of the helical superstructure. Extremely interesting effects with, inter alia, colour- and polarisation-selective reflections arise here. These have extensive potential for use, for example, in security printing of securities, banknotes, identity cards or the like. However, constantly increasing demands with respect to counterfeiting security of such documents increasingly make the introduction of additional security features necessary.

An object of the present invention is therefore to provide modified chiral liquid-crystal films which are suitable, in particular, for use in security markings, and processes for the production thereof.

It has been found that a method for the modification of LC films in accordance with the present invention is highly suitable for achieving this object. In this method, a polymerisable chiral, preferably cholesteric LC layer is brought into contact with a liquid extraction medium (extractant) in such a way that diffusion of substances out of the LC layer into the extractant occurs. In a first step, cholesteric LC materials or coatings are applied to a dark substrate surface in such a way that a homogeneous structure of the cholesteric phase is produced, and the LC layer is partially or fully cured. In a second step, an extractant is applied to the LC film by means of a suitable coating or printing method. During the diffusion and extraction process, a shift of the respective viewing angle-dependent reflection bands of the LC film into the region of shorter wavelengths takes place. The extractant may also be of such a nature that it carries out further tasks, for example optical, electro-optical or electrical tasks, in addition to the purely extracting function or optical modification of the LC film.

Patent Specification U.S. Pat. No. 6,071,438 and the corresponding German Laid-Open Specification DE 197 18 293 A1 describe the extraction of extractable components from partially or fully cured cholesteric LC films for the purposes of broadening the reflection bands of the cholesteric liquid crystals and the use of the resultant layers as broad-band filters, polarisers or reflectors. The described LC layers subjected to extraction have a thickness of 5 to 200 μm, particularly preferably between 15 and 80 μm. The attack by the extraction media is preferably carried out in such a way that a gradient of the network density is achieved. For the extraction, use is made of organic solvents or mixtures thereof which, owing to their chemical nature, are too unreactive for a further reaction, in particular a polymerisation. The extraction times vary in accordance with the working examples described in the range between 5 and 10 seconds, in each case followed by a 2-minute treatment at 90° C. for the purposes of evaporation of the residual solvent.

However, the method described in U.S. Pat. No. 6,071,438 and DE 197 18 293 A1 requires very precise control of the working steps and times, which results in a complex and expensive process. In addition, the heat treatment described restricts the support materials which can be used, since heat-sensitive support materials, such as, for example, films or thin plastic cards, cannot be used as they permanently deform on exposure to excessively high temperatures and thus cannot be processed further in a subsequent production step.

A process for the modification of the chiral LC layer by means of printing processes or application of the extractants is not described in U.S. Pat. No. 6,071,438 or DE 197 18 293 A1, and neither is the use of extraction media which themselves carry out tasks, for example those of an optical nature, after solidification by evaporation of the solvent or polymerisation or the like.

EP 0 606 940 A2 and the corresponding German Patent Specification DE 694 17 776 T2 describe a cholesteric broad-band polariser which has the characterising feature that the helical pitch increases virtually continuously from a minimum value at one surface of the layer to a maximum value at the other surface of the layer. This is accomplished, inter alia, in that one surface of an optically active layer of polymerisable LC material having cholesteric ordering is provided with a film of reactive monomers which cause a concentration gradient in the layer through diffusion. The diffusion of the monomers into the optically active layer enables this layer to swell. This swelling results in an increase in the pitch of the molecular spirals and, in the case of introduction of a concentration gradient of monomer over the thickness of the layer or correspondingly selected exposure time or the use of mixtures of monomers which diffuse at different rates, in a variation in the pitch of the molecular spirals. The diffusion in the optically active layer is terminated by polymerisation of the monomers.

However, the polarisers described in EP 0 606 940 A2 and DE 694 17 776 T2 have high thicknesses of the optically active layers in the region of 20 μm. In addition, the method described therein requires long diffusion times of about 10 minutes at 60° C. This is a disadvantage, in particular for the production of films on a large industrial scale.

WO 96/02597 and the corresponding German Laid-Open Specifications DE 44 41 651 A1 and DE 195 32 419 A1 describe a method for the coating and printing of substrates with polymerisable chiral LC materials which comprise a polymeric or polymerisable binder. However, a method for modification of the applied LC layers by extraction is not described therein.

A further object of the present invention is therefore to provide a method which avoids the disadvantages of the methods disclosed in the above-mentioned specifications. A further object of the present invention is to provide a means of permanently incorporating variable information into a cured liquid-crystal layer by an extraction method.

It has been found that the above-mentioned objects can be achieved by the provision of a method in accordance with the present invention, as described above and below.

The present application relates to a method for the modification of the optical properties of polymerisable or polymerised chiral liquid crystals, in particular for shifting their optical reflection band, preferably into the higher-energy region, characterised in that it comprises the following steps:
i) application of a first layer of a polymerisable or curable chiral liquid-crystal material to a support,
ii) partial or complete polymerisation or curing of the first layer of the polymerisable chiral liquid-crystal material,
iii) application of at least one further layer of one or more extraction media to the partially or fully polymerised or cured first liquid-crystal layer, and
iv) where appropriate complete polymerisation or curing of the first liquid-crystal layer and/or one or more of the further layers.

The application furthermore relates to a liquid-crystal film produced by a method in accordance with the present invention.

The application furthermore relates to a print product comprising one or more layers of a cured or polymerised chiral liquid-crystal material, produced by a method in accordance with the present invention.

The application furthermore relates to a print product according to the invention which comprises at least one birefringent marking.

The application furthermore relates to a print product having a print motif which is produced by a method in accordance with the present invention, characterised in that
i) the print motif has at least one region having a first optical effect, and
ii) the print motif has at least one region having a second optical effect which differs from the first optical effect through a shift of the optical reflection bands towards the higher-energy region.

The application furthermore relates to a print product according to the invention, characterised in that the liquid-crystal material and/or the extractants are applied by means of printing methods, in the case of the first layer optionally to a print substrate.

The application furthermore relates to a print product according to the invention, characterised in that at least one of the layers has an optically variable component for the production of optical effects.

The application furthermore relates to a print product according to the invention, characterised in that an optical effect is produced by the diffusion of components out of an applied medium of a first layer into another, second layer brought into contact therewith.

The application furthermore relates to the use of a liquid-crystal film or print product produced by a method in accordance with the present invention, as decorative element, security, authenticity or identification element, using information incorporated in a variable manner.

The application furthermore relates to a security feature, authenticity feature or identification feature comprising a liquid-crystal film according to the invention or a print product according to the invention.

The application furthermore relates to a security document, identity document or banknote, an ink-transfer film, reflective film, or an optical data carrier provided with at least one liquid-crystal film, print product, security feature, authenticity feature or identification feature in accordance with the present invention.

The present invention is based on the material side on polymerisable or curable printing inks which consist of chiral-nematic or cholesteric liquid-crystalline inks or coatings, or inks or coatings which are chiral-nemato-genic in their entirety. Preference is given here to the use of inks or coatings which are radiation-curing, particularly preferably UV-curing, and polymerise or cure on exposure to light, UV radiation, or electron beams.

In a first step of the method according to the invention, a film or a layer of chiral LC substances, preferably cholesteric substances, or substances which are chiral-mesogenic in their entirety, is applied to a substrate surface and cured, polymerised or crosslinked by means of suitable methods. The LC substances are preferably applied by means of a first printing method, such as, for example, flexographic printing, offset printing, gravure printing, relief printing or ink-jet printing, or with the aid of a first coating method, such as, for example, roller coating, spraying or dipping. A dark, in particular black or brown, substrate surface is preferably used. A homogeneous structure of the chiral mesophase is produced here, either spontaneously during application of the LC material or by means of suitable methods which are known to the person skilled in the art and are described in the literature. In the case of cholesteric liquid crystals, this is preferably planar alignment (Grandjean structure).

Suitable print substrates are, for example, films or foils made of plastic, paper, board, leather, cellulose, textiles, glass, ceramic or metal. Suitable plastics are, for example, polyester, such as polyethylene terephthalate (PET) or polyethylene naphthalate (PEN), polyvinyl alcohol (PVA), polycarbonate (PC), di- or triacetylcellulose (DAC, TAC), in particular PET or TAC. Particular preference is given to dark or blackened substrates.

In a second step, an extraction medium (extractant) is applied fully or partially to the LC film with the aid of a second suitable coating or printing method. During the diffusion and extraction process, a shift of the respective viewing angle-dependent reflection bands of the LC film into the region of shorter wavelengths occurs in the areas of the applied extractant. The extraction medium may additionally be of such a nature that it is able to carry out further tasks, for example optical, electro-optical or electrical tasks, via the purely extracting function or optical modification of the LC film.

Thus, for example, an ink as extractant can be applied by means of a continuous ink-jet device. The inks used in these devices are generally based on one or more solvents which have the properties according to the invention. If the ink selected here additionally comprises fluorescent dyes or pigments, a five-fold security feature comprising the polarising features of the LC layer, the viewing angle-dependent colour impression, the modified colour impression, the fluorescence in the areas where the ink-jet ink has been applied, and, through the use of a freely programmable ink-jet device, variable information is produced, for example in the form of a text, picture, bar code or the like. The type of fluorescence depends on the dyes or pigments used and can be rendered visible, for example, using UV light or by up-conversion using IR light.

If appropriate, in a third step after extraction, the LC film is fully polymerised or crosslinked, so that the chiral structure of the LC layer with the modified reflection wavelength is fixed, in particular if the extractants or components dissolved therein are themselves polymerisable in nature.

The cured LC film is preferably a polymer network.

Suitable LC materials are, in particular, photopolymerisable, for example UV-curable, printing inks of cholesteric liquid crystals, particularly polymerisable cholesteric LC compounds and mixtures, as described below, known from the prior art. As described at the outset, liquid crystals in the cholesteric phase form a helical superstructure perpendicular to the longitudinal axes of its molecules and exhibit high optical rotation and pronounced circular dichroism due to selective reflection of circular-polarised light within the layer. The colours, which appear different here depending on the viewing angle, are dependent on the pitch of the helical superstructure, which itself depends on the twisting power of the chiral component. The pitch can be varied here, in particular by changing the concentration of the chiral component, for example in the form of a chiral dopant, or changing the network density of the polymer skeleton. This variation in turn results in a change in the wavelength range of the selectively reflected light of the cholesteric layer.

If the chiral constituents of the LC films are therefore extracted out with the aid of a suitable extractant in the sense of the present application, or other non- or insufficiently polymerised constituents are removed in this way, this results in a reduction in the helical pitch and thus a shift of the reflection wavelengths into the higher-energy, shorter-wave region.

In a preferred embodiment, the extraction medium is a solvent or solvent mixture which cannot be polymerised by means of free radicals or cationically.

Suitable and preferred extractants are organic solvents, which can be divided, in accordance with their structural nature, into

(a) nonpolar aprotic solvents, which have small dipole moments and low dielectric constants, selected from, for example, hexane, benzene, toluene, carbon tetrachloride, dioxane, diethyl ether and tetrahydrofuran,

(b) polar aprotic solvents, which have large dipole moments and high di-electric constants, selected from, for example, acetone, nitrobenzene, di-methylformamide, dimethyl sulfoxide, methyl ethyl ketone (2-butanone) and ethyl acetate, and

(c) protic solvents, which contain highly polar OH or NH groups and are able to form hydrogen bonds to other molecules, selected from, for example, methanol, ethanol, ethylene glycol and aniline.

However, it is also possible to employ mixtures of these solvents. Representatives of the last-mentioned group (c), which have a relatively poor or negligible extraction power in respect of the LC materials according to the invention, are particularly suitable for reducing the strong to very strong extraction power of the representatives of the above-mentioned groups (a) and (b) or for facilitating fine dispensing of the extraction action of these solvents.

In a preferred embodiment, the extractant comprises one or more solvents selected from group (a).

In a further preferred embodiment, the extractant comprises one or more solvents selected from group (b).

In a further preferred embodiment, the extractant is a mixture comprising at least one solvent from group (a) and/or (b).

In a preferred embodiment, the extractant is a mixture comprising at least one solvent from group (a) and/or (b) and at least one solvent from group (c).

Extractants which, although firstly effecting a diffusion and extraction process on contact with the LC layer, can then, however, be completely polymerised randomly by means of suitable agents, such as, for example, UV radiation, are also advantageously suitable for the method according to the invention compared with Patent Specification U.S. Pat. No. 6,071,438.

In a further preferred embodiment, the extractants are, for example, commercially available varnishes which cure by means of free radicals or cationically and comprise no or only small amounts, preferably less than 5%, of unreactive organic solvents. The extraction action is in these cases attributable to the presence of other components, such as, for example, the binder precursors or monomers present in these varnishes, such as acrylates, diacrylates, triacrylates, epoxides or vinyl ethers, which have the ability firstly to dissolve substances out of the LC layer and secondly to react to form a molecular network. At least some of the monomers here should contain two or more polymerisable groups. This gives rise to the possibility of a three-dimensional network, which restricts further extraction.

In a further preferred embodiment, the extractants are LC compounds, in particular curable or polymerisable LC compounds, or mixtures thereof. In accordance with this preferred embodiment, a second, curable LC layer in the form of its liquid, smectic, nematic, cholesteric or isotropic phase is applied to the first LC layer applied to a substrate and cured in the first step described above, for example by means of a suitable coating or printing method. After a sufficiently long exposure time or after the first LC layer has been modified, the second LC layer is then cured. Through a suitable choice of the different compositions of the two LC layers, it is possible, for example, to achieve concentration gradients which result in diffusion of monomers out of the first LC layer, resulting in a reduced pitch difference of the helix in the first LC layer.

In a further preferred embodiment of the invention, the extractant consists of a solvent from the above-mentioned group (a) or (b) or a corresponding mixture of these solvents, and a further proportion of one or more components which, after evaporation of the solvent or solvent mixture, give a print film which is either already ready-to-use or solid or becomes ready-to-use or solid during an additional curing reaction, which is initiated, for example, by the action of actinic radiation.

The percentage of solvents from the above-mentioned group (a) or (b) or the mixture of (a) and (b) in the extractant depends, inter alia, on the choice of the application method and the application means suitable for this purpose, and is, for example, preferably 10% to 60% in the case of roller application methods and preferably 70% to 95% in the case of ink-jet methods.

In a further preferred embodiment, the extractants are mixtures of smectic, nematic or cholesteric LCs with organic solvents, particularly from the above-mentioned groups (a), (b) or corresponding mixtures thereof. These are applied to the first LC layer applied to a substrate and cured in the first step described above, for example by means of a suitable coating and printing method. After a sufficiently long exposure time or after the first LC layer has been modified, and after completed evaporation of the solvent or solvent mixture, the second LC layer is then cured.

However, it is generally preferred substantially to omit the use of non-polymerisable solvents, which are in many cases ecologically unacceptable.

In principle, the extractants employed can be printing or other inks and coatings which on the one hand cause a change in the colour- and polarisation-selective reflection of the LC layers, and on the other hand, as already stated, have their own optical effect. In the simplest case, this consists in a certain chromaticity and a certain gloss, which arise from the interaction of absorption, transmission and reflection.

Particularly relevant for security printing are printing and other inks and coatings which carry out more substantial functions, in particular have specific properties, such as, for example, thermal and electrical conductivity, magnetic susceptibility, dielectric, optical and elasto-mechanical anisotropy, fluorescence or phosphorescence. It is also possible for the extractant to be applied to have no optical effect per se, but instead for this only to arise in connection with the coating or printing of the under-lying cholesteric LC layer. The optical effects may augment, reinforce or cancel out one another. Furthermore, the said inks, printing inks and surface coatings may have functional properties, such as, for example, a glossy or matt surface, scratch resistance, or a dirt-repellent design.

In a further preferred embodiment of the invention, the diffusion of certain components out of a given LC layer into the extraction medium results not only in variation of the polarisation- and colour-selective reflection properties of the LC layer, but also in modification of the optical or reactive properties of the extraction medium or one or more constituents thereof. For example, chiral dopants which were not polymerised in the LC layer can diffuse out of the latter into the extraction medium, which, if it was, for example, of nematic nature, experiences twisting in this way, or if it was, for example, of cholesteric nature, experiences variation of its twist conditions and thus anisotropic properties. In a further preferred variant of this embodiment, extraction takes place out of the LC layer into the extraction medium of reactive constituents which are capable of reacting chemically with one or more components of the extractant and initiating, for example, curing thereof by polycondensation or polyaddition.

The design variants of the present application are distinguished by the fact that the change in the colour- and polarisation-selective reflection properties of an LC layer brought into contact with the liquid extraction medium takes place very rapidly, preferably in the region of 1 second, particularly preferably in the region of less than 1 second. Similar times may relate to secondary reactions to be taken into account in the extraction medium or one or more constituents thereof which, as already described, may in certain cases be initiated by components extracted out of the LC layer.

In contrast to U.S. Pat. No. 6,071,438, the extraction media or the extraction constituents of these media penetrate completely and uniformly through the LC layers in the method according to the present invention. The fact that homogeneous extraction is induced throughout the layer thickness of the LC film means that a gradient of the helical pitch, the network density or the refractive index does not arise over the layer thickness. Instead, a helical pitch which is smaller than the original pitch (i.e. before extraction) is formed in the LC layer.

The liquid extraction media (extractants) may be applied in the form of coating systems, printing inks and inks or in the form of pure organic solvents. Suitable application methods are in general dipping, spraying, roller coating, pouring, knife coating and printing. The temperatures are in the range between 0° C. and above 200° C. and are in particular dependent on the melting, phase-transition and boiling points of the media employed and of the LC layer to be modified. A particular role is also played here by the thermal conductivity of the LC layer and of the substrate or support material. All conventional printing methods can be used, for example relief, gravure, flexographic, offset, screen, embossed or ink-jet printing, where, for the purposes of the application, printing methods are also those in which the extraction medium is applied with the aid of a fountain pen or ball-point pen.

In a particularly preferred embodiment, the extraction medium is applied with the aid of commercially available ink-jet printers, for example from Metronic AG. For example, ink-jet devices of the “AlphaJet” type and ink-jet devices of the “BetaJet” type have been used. “AlphaJet” devices work in so-called “continuous flow operation” and use inks based on fast-evaporating solvents. “BetaJet” devices work in so-called “drop on demand operation” and use inks which are preferably free from solvents to be evaporated. Both methods are known to the person skilled in the art in respect of their technology and their advantages and disadvantages. Both technologies are suitable for the method according to the invention since the extraction medium to be printed can be adapted to both ink-jet printers corresponding to the said compositions. The inks here may additionally be warmed, influencing their extraction properties further. It is also possible to print pure organic solvents or solvent mixtures if these are provided, for example, with corresponding conductivity additives for use in a continuous ink-jet process.

After printing and completed extraction, the volatile solvent component present in the extract is either removed at elevated temperature or removed together with the components extracted out of the LC layer through the choice of suitable solvents. The latter is preferably carried out if the extraction media essentially consist only of solvents to be evaporated. Suitable solvents for the post-treatment are preferably those which do not attack the LC film or the applied secondary print or are solvents from group (c) mentioned above.

The cholesteric LC films subjected to the attack by the liquid extraction medium are applied to suitable, in particular chemical-insensitive print substrates with the aid of conventional printing methods. Suitable application methods are in general dipping, spraying, roller coating, pouring, knife coating and printing. All conventional printing methods can be used, for example relief, gravure, flexographic, offset, screen, embossed printing, ink-jetted printing, heat seal printing or other transfer printing methods. For the purposes of the application, printing methods are also those in which the cholesteric film is applied, for example, by means of a fountain pen or ball-point pen or other writing instrument.

The layer thicknesses of the LC films are preferably between 0.5 and 10 μm, particularly preferably between 1 and 5 μm and very particularly preferably between 1.5 and 3 μm. These low layer thicknesses, in contrast, for example, to Patent Specification U.S. Pat. No. 6,071,438, make a particular contribution to the implementation of the method according to the invention and its embodiments, since the extraction media are able to penetrate completely and very rapidly through the LC layers.

The degree of polymerisation or the network density of the cholesteric LC layer determines to a great extent the colour effect that is achieved during treatment with the media according to the invention. If the network density is too high, it is generally not possible for components to be extracted out of the LC layer. In an embodiment of the invention, the drying of the LC layer is therefore controlled in such a way that a certain proportion thereof remains unpolymerised. The maximum possible network density thus does not arise. This is carried out, for example in the case of drying by free-radical polymerisation, through the choice of relatively unreactive components, for example through the use of monoacrylates instead of di- or triacrylates or of methacrylates instead of acrylates, where appropriate through a correspondingly low UV irradiation intensity, a correspondingly short UV irradiation time, or through the use of filters which weaken the UV radiation, through inhibitors, the oxygen concentration in the drying atmosphere, through the concentration and choice of amines and, in the case of cationic polymerisation, via the concentration of ionic photoinitiators or via the influence of atmospheric humidity. UV-absorbent, dissolved, dispersed or suspended constituents in the LC layer are also suitable for permitting the polymerisation to proceed only incompletely.

In a preferred embodiment, the extractable constituents of the LC film are photopolymerisable components, in particular components which are reactive in the sense of free-radical or cationic photopolymerisation, but which are bonded only inadequately into the LC polymer or LC polymer network so that they are extractable. The polymerisable LC layer preferably comprises one or more such components.

In a further preferred embodiment, the polymer or polymer network of the LC layer comprises components which cannot be polymerised into it owing to their structural nature, and are thus extractable. Particularly preferred extractable constituents of the LC film are components which are unreactive in the sense of photopolymerisation, in particular in the sense of free-radical or cationic photopolymerisation. The polymerisable LC layer preferably comprises one or more such components.

Particular preference is given here to chemically unreactive or non-polymerisable chiral dopants which are introduced for the purpose of influencing the helical pitch of the cholesteric liquid crystals. If these constituents are completely or partially removed again by extraction out of the completely or partially cured LC film, the result is a change in the reflection properties of the LC film, which is evident in a shift of the reflected wavelengths into the higher-energy region.

“Completely cured LC or liquid-crystal film” in this connection means that the test criteria of “stackability” in accordance with DIN EN ISO 4622 and “drying-through” in accordance with DIN EN 29117 have been satisfied. “Partially cured LC films”, by contrast, may have been cured in such a way that they can be printed, for example with the aid of conventional plate printing processes without experiencing squashing. If this is not possible, non-contact printing processes are used, for example based on ink-jet printers.

In any case, the LC layers according to the invention have been cured to such an extent that the applied secondary prints comprising the extractants adhere sufficiently thereto and do not bleed or run.

In a preferred variant, the completely or partially cured LC films comprise molecules having reactive groups which are matched specifically to one or more components of the secondary print (of the extractant). In this way, for example, particularly good wetting of the LC layer with the extractant and adhesion or chemical bonding of the LC layer to the extractant can be achieved.

It is also possible to cure different regions of an LC film to different extents by varying the UV irradiation power in time or location and to coat them with an extraction medium in such a way that the less-cured regions are attacked to a greater extent than the better-cured regions, giving rise to different colour effects.

If only partially cured LC films are employed in accordance with the invention, they are dried completely and cured in a third step, after completed modification by extraction, with the aid of suitable methods known to the person skilled in the art.

In a further preferred embodiment, in the reverse manner, firstly the extraction medium is applied to a substrate, and the LC film is then printed on top. The LC film thereby only experiences modification of its chemical and physical properties in certain areas. It is also possible for regions to be pre-printed with different extractants of different extraction power, enabling a multicoloured image to be achieved after coating with the LC film.

In a further preferred embodiment, a plurality of LC layers with increasing receptivity to an extraction medium are printed one on top of the other, giving rise to further possibilities for achieving multicoloured images.

In a further preferred embodiment, an LC layer comprising extractable constituents is provided in certain prespecified areas, for example by means of a flexographic printing method, with a defined, transparent protective layer, which on the one hand does not undergo any interaction with the LC layer and on the other hand is resistant to attack by an extraction medium. Treatment with the extractant as described above is subsequently carried out, as a result of which only the unprotected regions, i.e. those not provided with the protective layer, of the LC layer experience a change in their properties. A further preferred variant of this embodiment relates to a method in which, instead of a defined, transparent, firmly adherent protective layer, a mask which can be detached or removed again is used.

In general, the method according to the invention and its embodiments also serve to make unauthorised intervention in protected regions of security documents, for example with the aid of the use of solvents, evident in such a way that a clear colour change of the cholesteric LC layer then occurs.

The LC material according to the invention is preferably a polymerisable LC material having a cholesteric or chiral-smectic, for example chiralsmectic C (or S_{C}*) phase, particularly preferably a cholesteric LC material. The LC material is preferably a mixture of two or more compounds, at least one of which carries one or more polymerisable groups. The polymerisable LC material preferably comprises at least one mesogenic compound having one polymerisable group (monoreactive compound) and at least one mesogenic compound having two or more polymerisable groups (di- or multireactive compound).

The polymerisable compounds mentioned above and below are preferably monomers.

The polymerisable LC material preferably comprises one or more polymerisable mesogenic compounds and at least one chiral compound. The chiral compound may be polymerisable or non-polymerisable. It may be a mesogenic or non-mesogenic compound.

Particular preference is given to a polymerisable LC material comprising at least one mesogenic or liquid-crystalline monomer having at least one, preferably two or more, polymerisable groups, and at least one chiral compound, which is optionally polymerisable and/or mesogenic.

Polymerisable mono-, di- or multireactive mesogenic compounds which are suitable for the present invention are known to the person skilled in the art or can be prepared by methods known per se, which are described in standard works of organic chemistry, such as, for example, Houben-Weyl, Methodn der organischen Chemie [Methods of Organic Chemistry], Thieme-Verlag, Stuttgart.

Typical examples of polymerisable mesogenic compounds which are suitable for the present invention are disclosed, for example, in WO 93/22397, EP 0 261 712, DE 195 04 224, WO 95/22586 and WO 97/00600. However, the compounds disclosed in these documents are merely intended to serve as examples without restricting the scope of the invention.

Examples of particularly suitable and preferred chiral and achiral polymerisable mono- and direactive mesogenic compounds (reactive mesogens) are shown in the following list, which is intended to explain the invention without restricting it

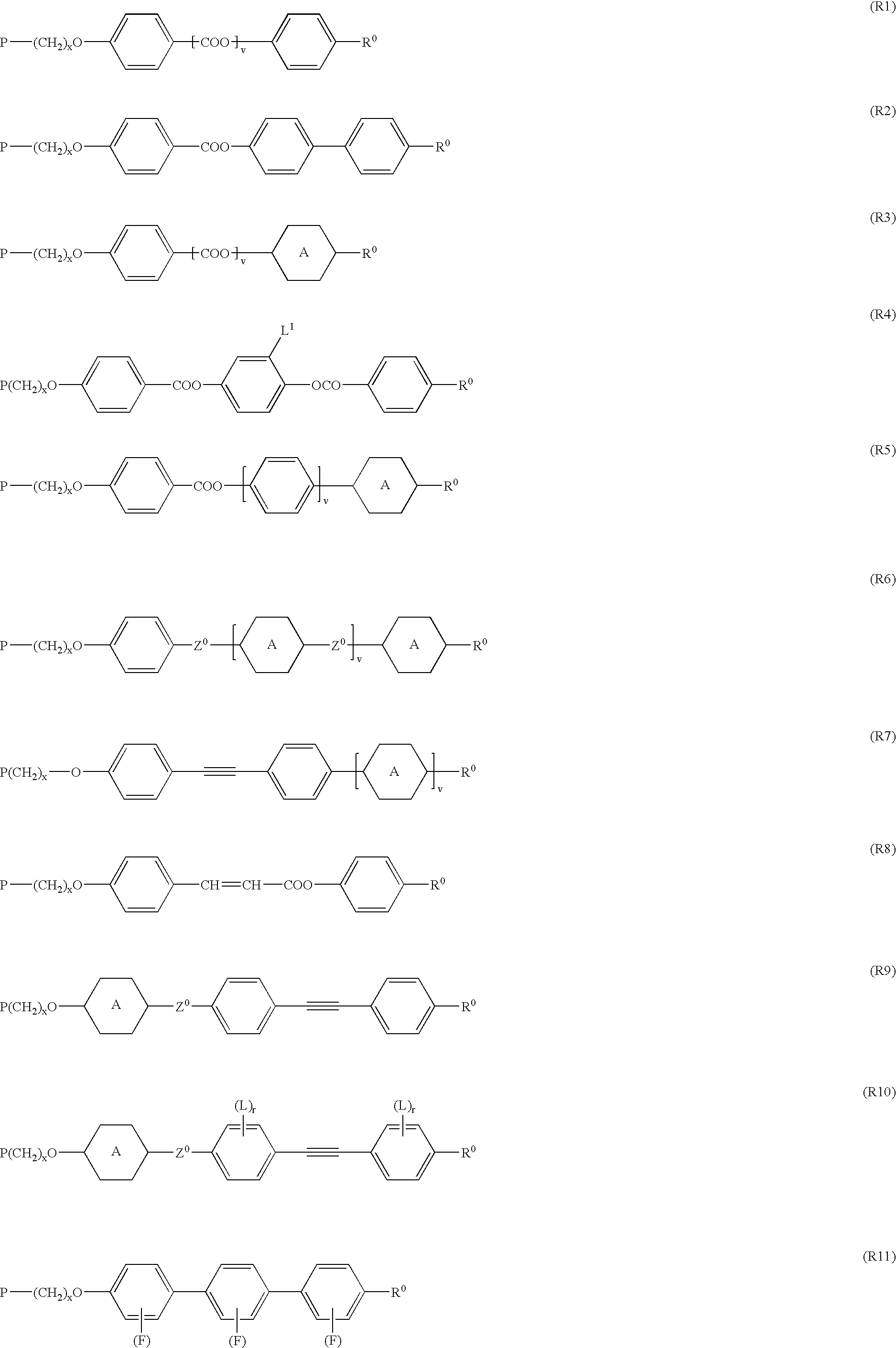

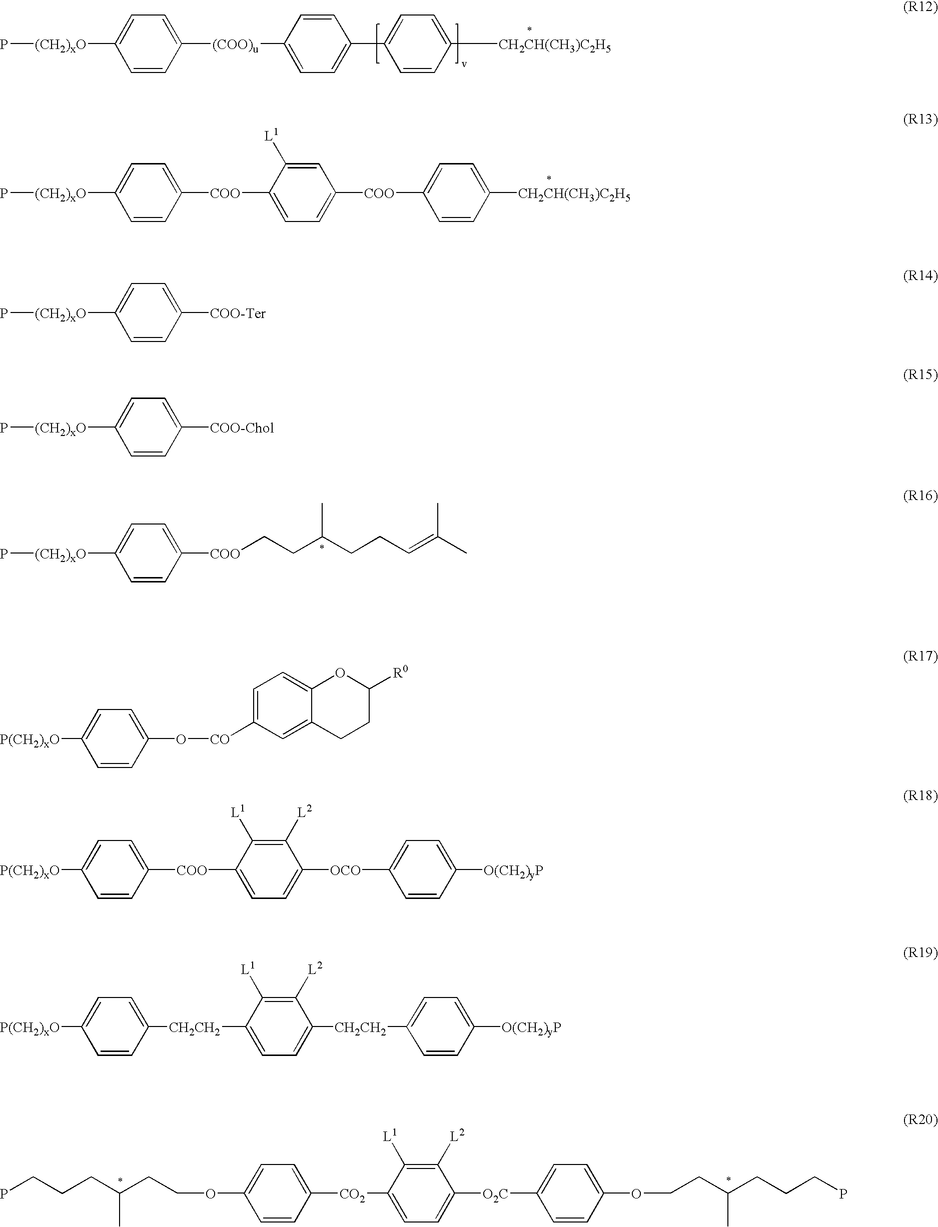

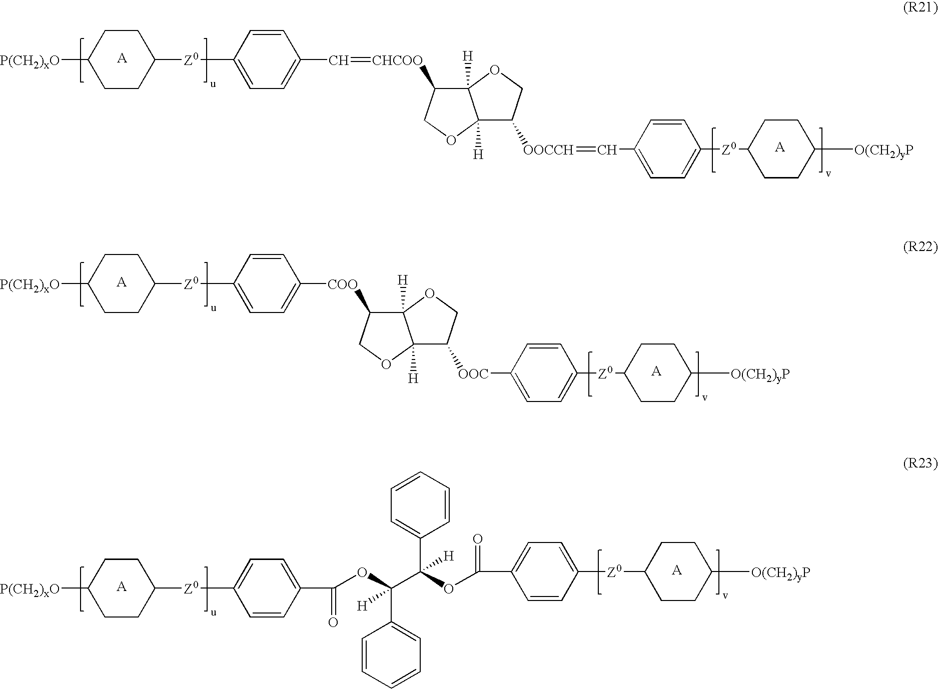

In the formulae shown above, P denotes a polymerisable group, preferably acryloyl, methacryloyl, vinyl, vinyloxy, propenyl ether, epoxide, oxetane or styryl, x and y each, independently of one another, denote an integer from 1 to 12, A denotes 1,4-phenylene, which may also be mono-, di-, tri- or tetrasubstituted by L¹, or 1,4-cyclohexylene, u and v each, independently of one another, denote 0 or 1, Z⁰ denotes —COO—, —OCO—, —CH₂CH₂—, —CH═CH—, —C≡C— or a single bond, R⁰ denotes a polar or nonpolar group, Ter denotes a terpene radical, such as, for example, menthyl, chol denotes a cholesteryl group, r denotes 0, 1, 2, 3 or 4, L, L¹ and L² each, independently of one another, denote H, F, Cl, CN or optionally halogenated alkyl, alkoxy, alkylcarbonyl, alkylcarbonyloxy, alkoxycarbonyl or alkoxycarbonyl-oxy having 1 to 7 C atoms. The phenyl rings in the formulae shown above are optionally mono-, di-, tri- or tetrasubstituted by L.

The term ‘polar group’ in this connection denotes a group selected from F, Cl, CN, NO₂, OH, OCH₃, OCN, SCN, optionally fluorinated alkylcarbonyl, alkylcarbonyloxy, alkoxycarbonyl or alkoxycarbonyloxy having up to 4 C atoms or mono-, oligo- or polyfluorinated alkyl or alkoxy having 1 to 4 C atoms. The term ‘nonpolar group’ in this connection denotes optionally halogenated alkyl, alkoxy, alkylcarbonyl, alkylcarbonyloxy, alkoxycarbonyl or alkoxycarbonyloxy containing alkyl having 1 or more, preferably 1 to 12, C atoms, which does not fall under the above definition ‘polar group’.

A preferred LC mixture comprises

a) one or more direactive achiral and/or chiral mesogenic compounds, and

b) one or more monoreactive achiral and/or chiral mesogenic compounds, where at least one of the components a) and b) comprises a chiral compound.

A further preferred LC mixture comprises

a) one or more direactive achiral mesogenic compounds,

b) one or more monoreactive achiral mesogenic compounds,

c) one or more non-polymerisable chiral compounds.

A particularly preferred LC mixture comprises
a) 5-70%, preferably 5-50%, particularly preferably 5-40%, of one or more direactive achiral and/or chiral mesogenic compounds,
b) 30-95% preferably 50-75%, of one or more monoreactive achiral and/or chiral mesogenic compounds.

A further preferred LC mixture comprises
a) 5-70%, preferably 5-50%, particularly preferably 5-40%, of one or more direactive achiral mesogenic compounds,
b) 30-95% preferably 50-75%, of one or more monoreactive achiral and/or chiral mesogenic compounds,

c) 0.1 to 15%, preferably 0.5 to 10%, particularly preferably 1 to 5%, of one or more non-polymerisable chiral compounds.

The monoreactive compounds are preferably selected from the formulae Ia-Ig and Ii, particularly preferably Ia, Ie and Ig, in which v is 1.

The direactive compounds are preferably selected from the formulae IIa and IIb, particularly preferably IIa.

The polymerisable chiral compounds are preferably selected from the formulae Ik to Iq and IIc to II, particularly preferably Ik.

Particularly preferred chiral compounds are chiral dopants known from the prior art which are employed for the production of twisted liquid-crystal phases.

Suitable dopants are selected, for example, from the commercially available compounds cholesteryl nonanoate (CN), CB15, R/S-811, R/S-1011, R/S-2011, R/S-3011 or R/S-4011 (Merck KGaA, Darmstadt). Particularly suitable are dopants having a high twisting power, for example chiral sugar derivatives, in particular derivatives of dianhydrohexitols, such as isosorbitol, isomannitol or iditol, particularly preferably isosorbitol derivatives, as disclosed, for example, in WO 98/00428. Preference is furthermore given to hydrobenzoin derivatives, as described, for example, in GB 2,328,207, chiral binaphthyls, as described, for example, in WO 02/94805, chiral binaphthols, as described, for example, in WO 02/34739, chiral TADDOLs, as described, for example, in WO 02/06265, and chiral compounds having a fluorinated bridging group and a terminal or central chiral group, as described, for example, in WO 02/06196 and WO 02/06195.

In a preferred embodiment, the LC material comprises up to 70%, preferably 1 to 50%, of one or more non-mesogenic compounds having a polymerisable group, such as, for example, alkyl acrylates or alkyl methacrylates having alkyl groups having 1 to 20 C atoms.

In a further preferred embodiment, the LC material comprises up to 40%, preferably 1 to 20%, of one or more non-mesogenic compounds having two or more polymerisable groups, such as, for example, alkyl diacrylates or alkyl dimethacrylates having 1 to 20 C atoms, or polyfunctional cross-linking agents, such as, for example, trimethylpropane trimethacrylate or pentaerythritol tetraacrylate.

In a further preferred embodiment, the LC material comprises one or more chain-transfer reagents, for example thiol compounds, such as dodecane thiol or trimethylpropane tri(3-mercaptopropionate), in particular liquid-crystalline thiol compounds. The free chain length of the LC polymers or the chain length between two crosslinking points can, for example, be reduced by addition of such reagents.

In a further preferred embodiment, the LC material comprises one or more polymeric or polymerisable binders or dispersion aids, as described, for example, in WO 96/02597.

The polymerisable LC material may also comprise further components or assistants, such as, for example, catalysts, sensitisers, stabilisers, chain-transfer reagents, inhibitors, comonomers, surface-active substances, plasticisers, wetting agents, dispersion aids, flow-control agents, viscosity reducers, hydrophobicising agents, adhesion agents, flow agents, anti-foaming agents, deaeration or degassing agents, diluents, reactive thinners, dyes, colorants or pigments.

In a further preferred embodiment, the LC material comprises one or more additives, for example surface-active substances, which induce or reinforce a planar alignment of the LC molecules on the substrate. Suitable substances are known to the person skilled in the art and are described, for example, in J. Cognard, Mol. Cryst. Liq. Cryst. 78, Supplement 1, 1-77 (1981). Particular preference is given to nonionic compounds, for example nonionic fluorocarbons, such as the commercially available Fluorad FC-171® (3M) or Zonyl FSN® (DuPont).

In general, however, the shear forces which occur during coating or printing of the LC material onto the substrate are sufficient for the spontaneous formation of a homogeneous, macroscopically uniform planar alignment of the LC molecules in the cholesteric phase.

The coating or printing of the substrate with the LC material is preferably followed by a drying process, which is preferably carried out under inert gas (for example nitrogen or argon) owing to the polymerisable curing constituents of the LC material and the particular sensitivity of the planar structure to chemical and physical influences.

In a further step, the LC layer is coated or printed with the extractant. The extraction processes cause the colour of the LC layer to shift into the short-wave region, untouched regions remain unchanged.

In the next step, the partial polymerisation or curing of the LC layer in situ takes place, preferably by treatment with actinic radiation, such as, for example, irradiation with light, in particular UV light, IR light or visible light, X-rays, gamma rays or high-energy particles, such as, for example, ions or electrons. Particular preference is given to photopolymerisation, in particular polymerisation by mans of UV light. The radiation source used can be, for example, an individual UV lamp or a series of UV lamps. Other possible radiation sources are, for example, light-emitting semiconductors, such as LEDs or semiconductor lasers, or lasers in general, such as UV lasers, IR lasers or lasers in the visible wavelength region.

For example, it is possible to employ one or more mercury low-pressure lamps, each having an irradiance of 10 mW/cm², which are arranged transversely to the running direction of the substrate during the coating process. Owing to the favourable temperature profile of these radiation sources, further heating of the LC material during the drying operation does not occur. The extent of the polymerisation can be controlled via the number of low-pressure lamps employed and the prespecified curing rate. Thus, for example, a dry, but non-stackable LC layer can be produced. As this is not fully cured and comprises a non-polymerisable or unreactive chiral dopant as extractable constituent, this has the ideal prerequisites for implementation of the method according to the invention.

The polymerisation is preferably carried out in the presence of an initiator which absorbs the actinic radiation. In the case of UV photopolymerisation, use is made, for example, of a photoinitiator which decomposes on UV irradiation and in the process liberates free radicals or ions which initiate a polymerisation reaction. UV photoinitiators are particularly preferred. Such photoinitiators are known to the person skilled in the art and are commercially available, such as, for example, Irgacure® 907, Irgacure® 651, Irgacure® 184, Darocure® 1173 or Darocure® 4205 (Ciba AG) or UVI 6974 (Union Carbide).

In the next step, the final curing of the previously only partially cured LC layer optionally takes place. In contrast to the prior step, the LC layer is now much less sensitive to heat or curing in the presence of atmospheric oxygen. The final curing is preferably carried out using a stronger radiation source than in the case of partial curing, for example a conventional medium-pressure lamp having a UV irradiance of, for example, 1 W/cm², so that the UV radiation passes through the LC layer without a relevant drop in intensity, and the LC regions more remote from the UV lamp are also finally cured. Sensitivity to the extractant is generally no longer present after the final curing or is no longer present to the same extent as before the curing.

If necessary, however, a protective coating which is insensitive to certain substances can also be applied to the LC layer in a fourth step. Suitable for this purpose are commercially available radiation-curing coatings, for example of the 806.961 type from Sicpa.

The following examples are intended to explain the invention without restricting it.

### EXAMPLE 1

In a first step, the polymerisable cholesteric LC mixture C1 is printed onto a blackened polyethylene terephthalate film via a flexographic printing machine heated to 70° C.

C1:

| | |
|---|---|
| (A) | 17.65% |
| (B) | 37.47% |
| (C) | 32.26% |
| (D) | 3.69% |
| (E) | 4.86% |
| Addid 900 | 1.00% |
| Irgacure 369 | 2.99% |
| Irganox 1076 | 0.08% |

| | |
|---|---|
| | (A) |
| 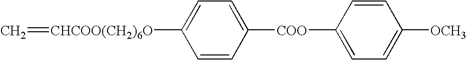 | |
| | (B) |
| 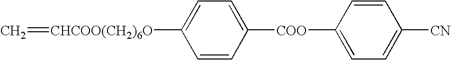 | |
| | (C) |
| 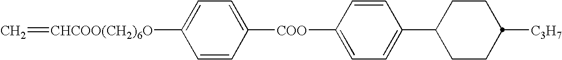 | |
| | (D) |
| 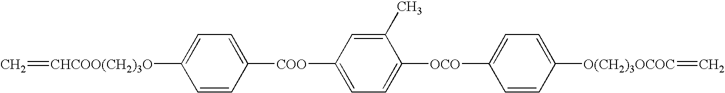 | |
| | (E) |
| 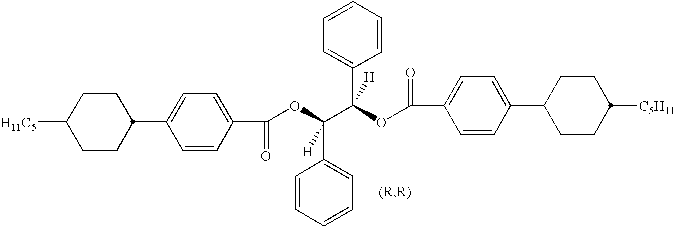 | |

Compounds (A), (B) and (D) can be prepared as described in D. J. Broer et al., Makromol. Chem. 190, 3201-3215 (1989) or analogously thereto. Compound (C) is known from GB 2,280,445 A1. Compound (E) is known from GB 2,328,207 A1. Irgacure 369®is a commercially available photo-initiator (Ciba Geigy). Irganox 1076® is a commercially available stabiliser (Ciba Geigy). Addid 900® is a commercially available adhesion agent (Wacker GmbH).

The cholesteric mixture C1 comprises, in an amount of about 4.9% by weight, a chiral dopant (E) from the class of the dihydrobenzoins which does not contain photopolymerisable functional groups. The film has a temperature of about 20° C.

The shear forces which act on the constituents of the mesomorphic phase during pressing of the printing plate onto the film, the sudden temperature drop from 70° C. to about 20° C. and the achievement of a layer thickness of about 2 μm which is usual in flexographic printing make a particular contribution towards the homogeneous structure of the cholesteric liquid-crystal phase. A print motif which has colour- and polarisation-selective properties is obtained here. The dimensions are specified, inter alia, both by the printing plate used and also by the anilox and plate roll. The term “print motif” relates to images and characters in the order of a few mm to the full area, as required.

The ink application is followed by drying of the LC layer under an inert gas (nitrogen or argon). For partial curing, the LC layer is then irradiated with UV light. The radiation sources employed here are mercury low-pressure lamps, each having a UV-C irradiance of 10 mW/cm², which are arranged transversely to the running direction of the film. Owing to the favourable temperature profile of these radiation sources, further heating of the LC mixture during the drying operation does not occur. A drying rate of 20 m/min and an irradiation separation of 8 mm gives a dry, but non-stackable LC layer with a thickness of 2 μm which is not fully cured and comprises an extractable constituent in the form of the chiral dopant.

In a second step, part of the LC layer is printed with an extractant with the aid of a Metronic AG ink-jet printer operating in continuous flow operation. The extraction processes shift the colour of the LC layer into the short-wave region, unextracted regions remain unchanged. The ink consists of a mixture of the solvents 2-butanone, ethyl acetate and acetone as well as binders, flow-control agents, wetting agents and assistants which together give a solid, transparent ink film after evaporation of the solvents.

In a third step, the final curing of the previously only partially cured LC layer is carried out using a conventional mercury medium-pressure lamp, so that the UV light passes through the ink-jet print from the second step without a relevant drop in intensity, and the LC regions located there are also finally cured.

In an optional fourth step, the cured LC layer is coated with a protective coating which is insensitive to certain substances.

1. Method for the modification of the optical properties of polymerisable or polymerised chiral liquid crystals, characterised in that it comprises the following steps:
i) application of a first layer of a polymerisable or curable chiral liquid-crystal material to a support,
ii) partial or complete polymerisation or curing of the first layer of the polymerisable chiral liquid-crystal material,
iii) application of at least one further layer of one or more extraction media to the partially or fully polymerised or cured first liquid-crystal layer, and
iv) where appropriate complete polymerisation or curing of the first liquid-crystal layer and/or one or more of the further layers.

2. Method according to claim 1, characterised in that the polymerisable liquid-crystal material comprises at least one mesogenic or liquid-crystalline monomer containing at least one polymerisable group and at least one chiral compound, which is optionally polymerisable and/or mesogenic.

3. Method according to claim 1, characterised in that the extraction medium is a solvent or solvent mixture which cannot be polymerised cationically or by means of free radicals or is unreactive to cationic or free-radical polymerisation.

4. Method according to claim 1, characterised in that the extraction medium is a solvent or solvent mixture which can be polymerised cationically or by means of free radicals.

5. Method according to claim 1, characterised in that the extraction medium comprises one or more solvents selected from the following groups
(a) nonpolar aprotic solvents, which have small dipole moments and low dielectric constants, such as hexane, benzene, toluene, carbon tetrachloride, dioxane, diethyl ether or tetrahydrofuran,
(b) polar aprotic solvents, which have large dipole moments and high dielectric constants, such as acetone, nitrobenzene, dimethylformamide, dimethyl sulfoxide, methyl ethyl ketone (2-butanone) or ethyl acetate, and
(c) protic solvents, which contain highly polar OH or NH groups and are able to form hydrogen bonds to other molecules, such as methanol, ethanol, ethylene glycol or aniline.

6. Method according to claim 1, characterised in that the extraction medium is a printing ink.

7. Method according to claim 1, characterised in that the extraction medium is transparent.

8. Method according to claim 1, characterised in that the extraction medium comprises one or more dyes and/or pigments which absorb in the visible or invisible region of the electromagnetic spectrum.

9. Method according to claim 8, characterised in that at least one dye and/or pigment is fluorescent.

10. Method according to claim 1, characterised in that the extraction medium has further functional properties in the cured state.

11. Method according to claim 10, characterised in that the functional properties are of an optical, electrical or mechanical nature.

12. Method according to claim 1, characterised in that the extraction medium comprises one or more mesogenic or liquid-crystalline compounds or essentially consists of this (these) compound(s), which are applied in the pure state or dissolved in a solvent.

13. Method according to claim 1, characterised in that the extractable constituents of the first liquid-crystal layer consist of polymerisable, but non- or only partially polymerised components.

14. Method according to claim 1, characterised in that the extractable constituents of the first liquid-crystal layer consist of non-polymerisable components.

15. Method according to claim 14, characterised in that the extractable components are chiral, non-polymerisable dopants.

16. Method according to claim 1, characterised in that the first liquid-crystal layer is applied to the support in step i) by means of a printing method or a coating method.

17. Method according to claim 1, characterised in that at least one of the further layers in step iii) is applied by means of a printing method or a coating method.

18. Liquid-crystal film produced by a method according to claim 1.

19. Print product comprising one or more layers of a cured or polymerised chiral liquid-crystal material, produced by a method according to claim 1.

20. Print product according to claim 19, characterised in that it comprises at least one birefringent marking.

21. Print product according to claim 19, characterised in that at least one of the layers has been applied using an ink-jet printer.

22. Print product having a print motif according to claim 19, characterised in that
i) the print motif has at least one region having a first optical effect, and
ii) the print motif has at least one region having a second optical effect which differs from the first optical effect through a shift of the optical reflection bands towards the higher-energy region.

23. Print product according to claim 19, characterised in that at least one of the layers has an optically variable component for the production of optical effects.

24. Print product according to claim 19, characterised in that an optical effect is produced by the diffusion of components out of an applied medium of a first layer into another, second layer brought into contact therewith.

25. Use of a liquid-crystal film or print product according to claim 18 as decorative element, security element, authenticity element or identification element.

26. Security feature, authenticity feature or identification feature comprising a liquid-crystal film or a print product according to claim 18.

27. Identity document, banknote, security document, ink-transfer film, reflective film or optical data carrier provided with a liquid-crystal film or print product according to claim 18.
